(19) United States
(12) Patent Application Publication
(10) Pub. No.: US 2006/0114182 A1
(43) Pub. Date: Jun. 1, 2006

(54) Plasma display panels and driving methods therefor

(75) Inventor: Yao-Ching Su, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/138,240

(22) Filed: May 26, 2005

(30) Foreign Application Priority Data
Nov. 11, 2004 (TW) 93134421

(51) Int. Cl. G09G 3/28

(52) U.S. Cl. 345/67

(57) ABSTRACT

A plasma display panel comprises a display array and an electrode driver. The display array is constructed by sustaining electrodes, scan electrodes, and electrodes. Each scan electrode is parallel to the sustaining electrodes and disposed between two sustaining electrodes. The electrode driver drives a first scan electrode and a second scan electrode adjacent to the first scan electrode. In a first period, discharge occurs between the first scan electrode and a first sustaining electrode on one side of the first scan electrode to display a first image. In a second period different from the first period, discharge occurs between the first scan electrode and a second sustaining electrode on the other side of the first scan electrode to display a second image.

### BACKGROUND

The invention relates to plasma display panels, and in particular to methods for driving plasma display panels.

Plasma display devices provide a large flat display screen for full-color images. According to driving methods of current plasma display panels (PDPs), as shown in FIG. 1, each frame is divided into eight sub-fields SF0˜SF7. Each sub-field includes three operating periods, that is, the erase period, the address period, and the sustain period.

FIG. 2 shows a conventional PDP device. A display array 20 of PDP 2 is constructed by sustaining electrodes X₁ to Xₙ, scan electrodes Y₁ to Yₙ, and address electrodes D₁ to Dₘ. The address electrodes D₁ to Dₘ are perpendicular to the sustaining electrodes X₁ to Xₙ and scan electrodes Y₁ to Yₙ. The sustaining electrodes X₁ to Xₙ, the scan electrodes Y₁ to Yₙ, and the address electrodes D₁ to Dₘ are driven by a sustaining driver 21, a scan driver 22, and a data driver 23 respectively.

Referring to FIGS. 1 and 2, in the erase periods R0 to R7, the residual charges of the former sub-field are cleared to normalize the initial conditions of all display units before the address periods A0 to A7. In the address period A0 to A7, address discharges are initiated in the selected display units according to the display data and wall charges are accumulated. That is, the scan driver 22 scans the scan electrodes Y₁ to Yₙ sequentially and transmits address pulses containing the display data to the scan electrodes Y₁ to Yₙ. The wall charges are built to the selected display units by the address discharges between the scan electrodes Y₁ to Yₙ and the address electrodes D₁ to Dₘ. In the sustain periods S0 to S7, sustain discharges for display are repeatedly initiated and visible light is produced in the display units which have accumulated charges through the address discharge in the address periods A0 to A7.

Plasma display devices can provide increased brightness by utilizing delta structure therein. When delta structure is applied in large and high resolution PDPs, however, the increased number of scan electrodes increases the duration of each address period, resulting in decreased duration of each sustain period and decreased brightness. In the related art, the above problems can be solved by utilizing dual scans. FIG. 3 shows a structure of a panel within a plasma display device utilizing dual scans. PDP 3 comprises two display arrays 30 and 30′. Display array 30 is constructed by sustaining electrodes X₁ to Xₚ, scan electrodes Y₁ to Yₚ, and address electrodes D₁ to Dₘ. Display array 30′ is constructed by sustaining electrodes X′₁ to X′ₚ, scan electrodes Y′₁ to Y′ₚ, and address electrodes D′₁ to D′ₘ.

A scan driver 32 controls the scan electrodes Y₁ to Yₚ and Y′₁ to Y′ₚ. A sustaining driver 31 controls the electrodes X₁ to Xₚ and X′₁ to X′ₚ. A data driver 33 controls the address electrodes D₁ to Dₘ, while a data driver 34 controls the address electrodes D′₁ to D′ₘ. In a frame, the data drivers 33 and 34 drive the respective address electrodes simultaneously to decrease the duration of each address period. Compared with the PDD 2 in FIG. 2, however, the PDP 3 in FIG. 3 has more data drivers, resulting in increased size and cost.

### SUMMARY

Plasma display panels are provided. An exemplary embodiment of a plasma display panel comprises a display array and an electrode driver. The display array is constructed by a plurality of sustaining electrodes, a plurality of scan electrodes, and a plurality of address electrodes. The scan electrodes are parallel to the sustaining electrodes, and each scan electrode is disposed between two sustaining electrodes. Each address electrode intersects the sustaining electrodes and the scan electrodes at a distance. The electrode driver drives a first scan electrode and a second scan electrode adjacent to the first scan electrode. In a first period, the discharge occurs between the first scan electrode and a first sustaining electrode on one side of the first scan electrode to display a first image. In a second period different from the first period, discharge occurs between the first scan electrode and a second sustaining electrode on the other side of the first scan electrode to display a second image.

Driving methods are provided. An exemplary embodiment of a driving method is applied in a plasma display panel. The plasma display panel comprises a plurality of sustaining electrodes, a plurality of scan electrodes, and a plurality of address electrodes. The scan electrodes are parallel to the sustaining electrodes, and each scan electrode is disposed between two sustaining electrodes. Each address electrode intersects the sustaining electrodes and the scan electrodes at a distance. An embodiment of the driving method comprises driving a first scan electrode and a second scan electrode adjacent to the first scan electrode simultaneously to discharge between the first scan electrode and a first sustaining electrode on one side of the first scan electrode to display a first image, and driving the first and second scan electrodes simultaneously to discharge between the first scan electrode and a second sustaining electrode on the other side of the first scan electrode to display a second image.

### DESCRIPTION OF THE DRAWINGS

The invention will become more fully understood from the detailed description given hereinbelow and the accompanying drawings, given by way of illustration only and thus not intended to be limitative of the invention.

FIG. 1 shows the timing for driving one frame of a conventional plasma display panel.

FIG. 2 is shows a conventional plasma display panel.

FIG. 3 shows a conventional plasma display panel utilizing dual scans.

FIG. 4 shows an embodiment of a plasma display panel.

FIG. 5 shows an arrangement of display units of the plasma display panel of FIG. 4.

FIGS. 6 and 7 show two fields according to the arrangement of the display units of FIG. 5.

FIG. 8 shows an arrangement of display units of the plasma display panel of FIG. 4.

FIGS. 9 and 10 show two fields according to the arrangement of the display units of FIG. 8.

FIG. 11 shows an embodiment of a plasma display panel.

FIG. 12 shows an arrangement of display units of the plasma display panel of FIG. 11.

FIGS. 13 and 14 show two fields according to the arrangement of the display units of FIG. 12.

FIGS. 15 to 18 show four fields according to the arrangement of the display units of FIG. 12.

FIG. 19 shows an embodiment of a plasma display panel.

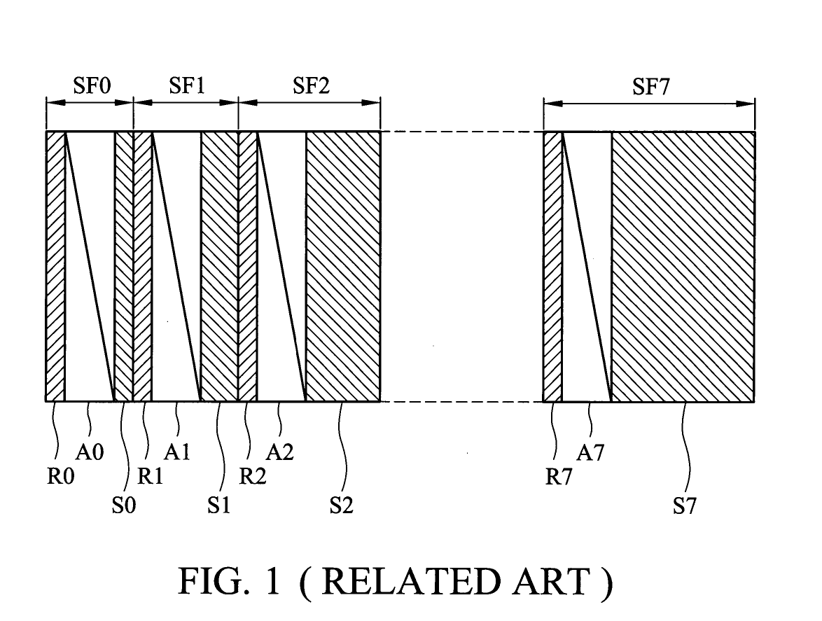

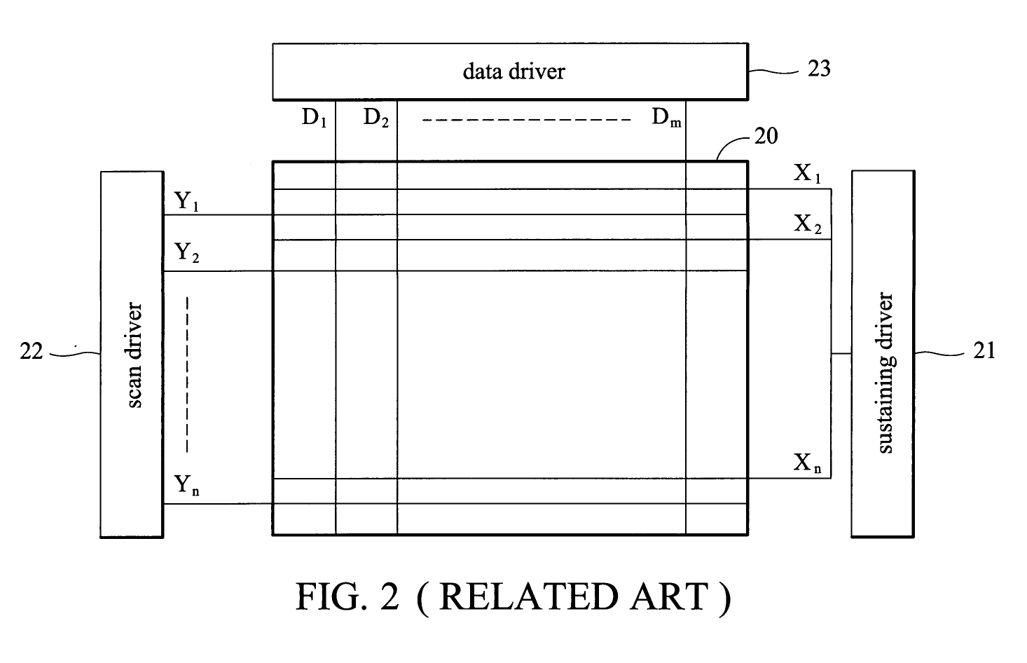

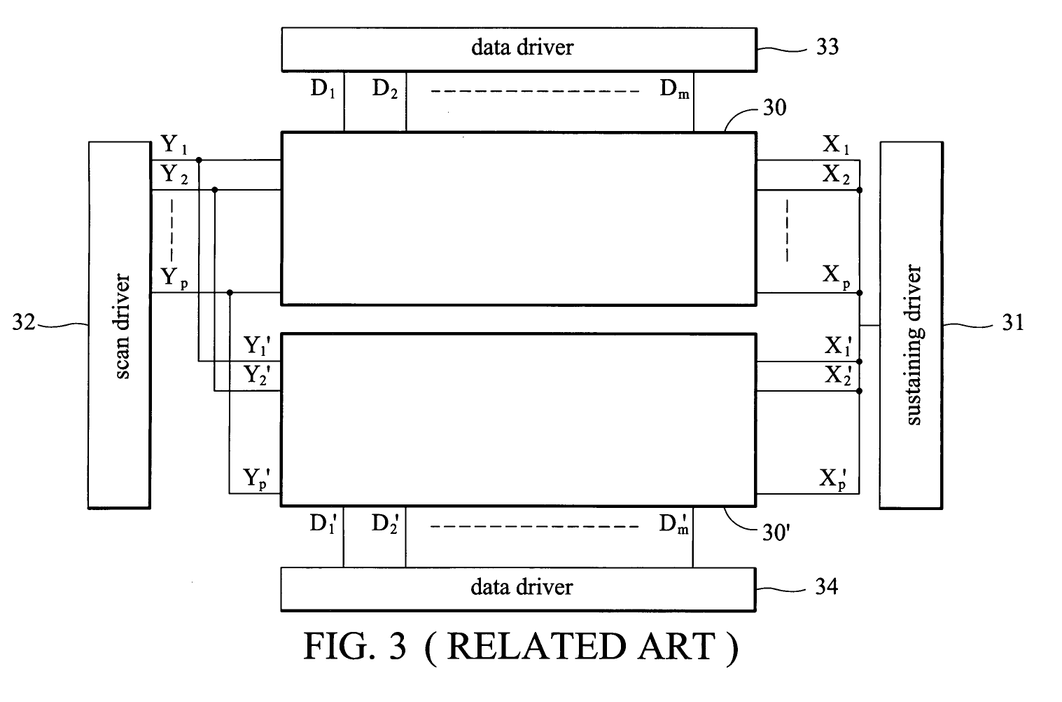

### DETAILED DESCRIPTION

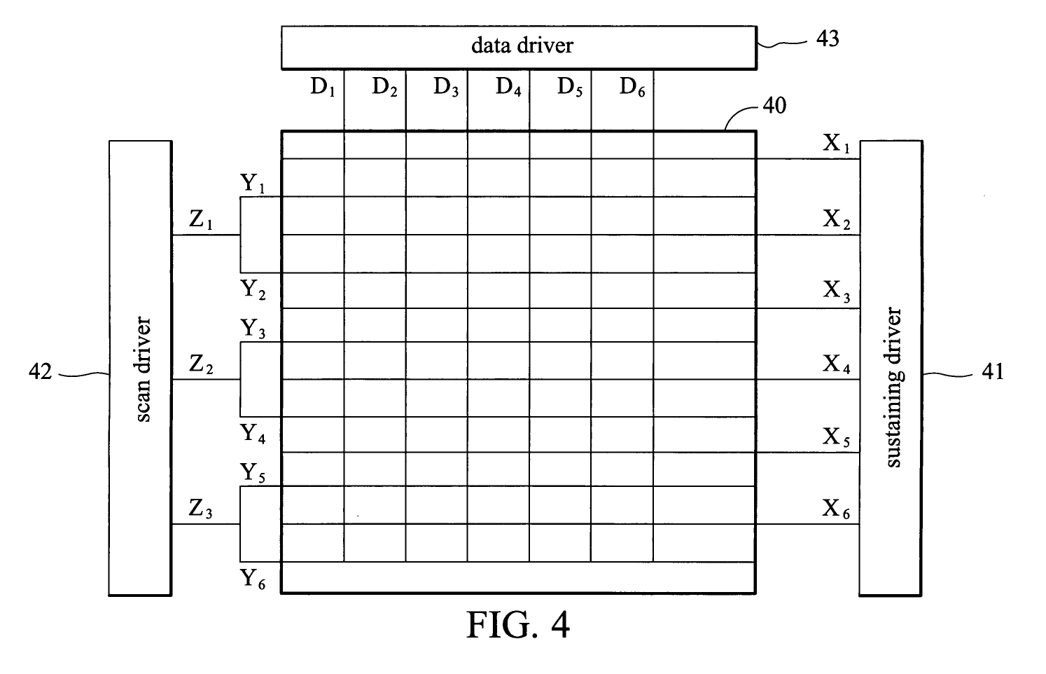

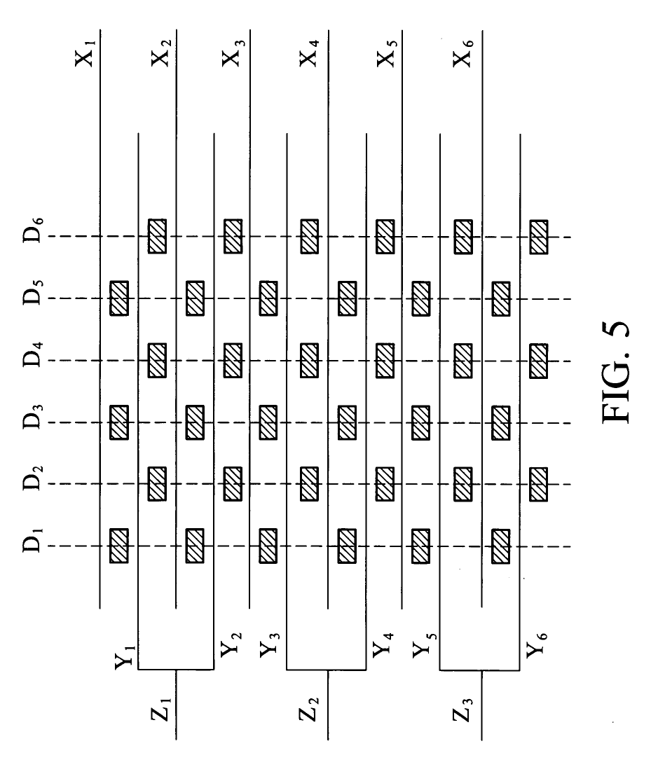

Plasma display panels (PDPs) are provided. In some embodiments, as shown in FIG. 4, a PDP 4 comprises a display array 40, a sustaining driver 41, a scan driver 41, and a data driver 43. The display array 40 comprises a plurality of display units and is constructed by a plurality of sustaining electrodes, a plurality of scan electrodes, and a plurality of address electrodes. The scan electrodes are parallel to the sustaining electrodes. The address electrode intersects the scan electrodes and the sustaining electrodes at a distance. In the embodiment shown in FIG. 4, six sustaining electrodes X₁ to X₆, six scan electrodes Y₁ to Y₆, and six address electrodes D₁ to D₆ are provided as an example. The scan electrodes Y₁ to Y₆ and the sustaining electrodes X₁ to X₆ are disposed alternately. A sustaining driver 41 controls the sustaining electrodes X₁ to X₆. A scan driver 42 controls the scan electrodes Y₁ to Y₆ through three link scan electrodes Z₁ to Z₃. The link scan electrode Z₁ is coupled to the scan electrodes Y₁ and Y₂, the link scan electrode Z₂ is coupled to the scan electrodes Y₃ and Y₄, and the link scan electrode Z₃ is coupled to the scan electrodes Y₅ and Y₆, that is, two adjacent scan electrodes are coupled to each other by the corresponding link scan electrode. In other words, the scan driver 42 controls the scan electrodes Y₁ and Y₂ at the same time, controls the scan electrodes Y₃ and Y₄ at the same time, and controls the scan electrodes Y₅ and Y₆ at the same time. The data driver 43 controls the address electrodes D₁ to D₆. In the embodiment of FIG. 4, the display units of the display array 40 are arranged in delta structure, as shown in FIG. 5.

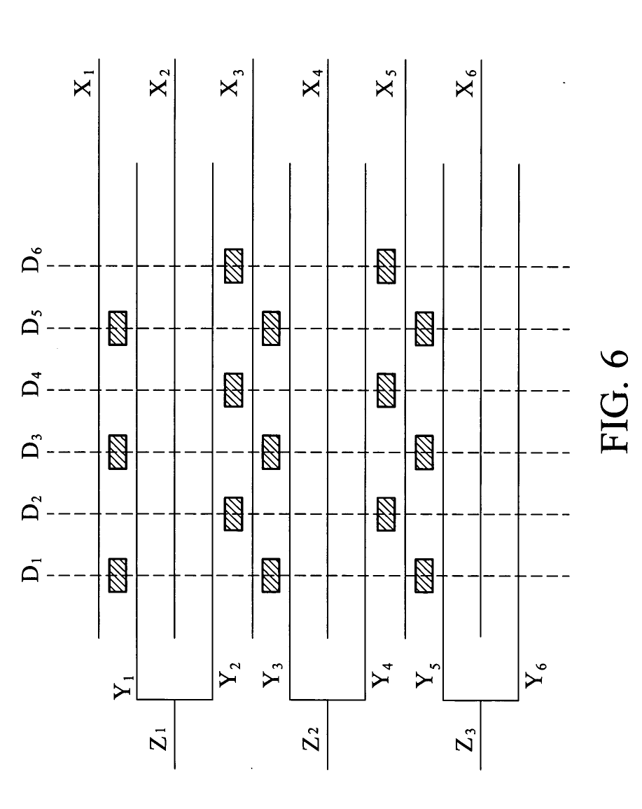

In this embodiment, one frame is divided into a first field and second field, each having a plurality of sub-fields. Each sub-field includes three operating periods, that is, an erase period, an address period and a sustain period. It is assumed that the PDP 4 displays an image with a single gray-level. In each sub-field of the first field, the data driver 43 provides an address pulse with address voltage to the address electrodes D₁ to D₆, the scan driver 42 drives the link scan electrodes Z₁ to Z₃ sequentially, and the sustaining driver 41 drives the sustaining electrodes X₁, X₃, and X₅ simultaneously. Referring to FIG. 6, discharge occurs between the scan electrode Y₁ and the sustaining electrode X₁, between the scan electrode Y₂ and the sustaining electrode X₃, between the scan electrode Y₃ and the sustaining electrode X₃, between the scan electrode Y₄ and the sustaining electrode X₅, and between the scan electrode Y₅ and the sustaining electrode X₅. The discharged display units of the display array 40 irradiate to form the first field, that is, the PDP 4 displays a first image.

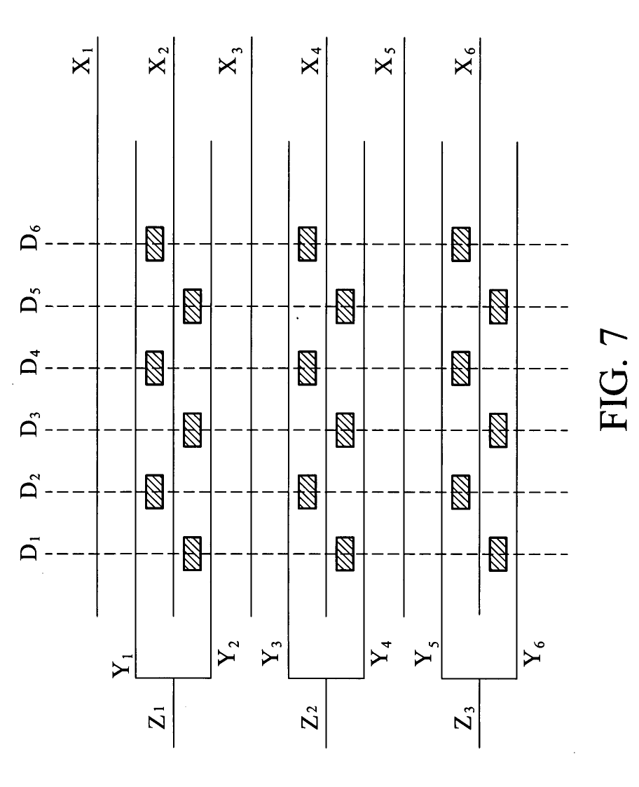

In each sub-field of the second field, the data driver 43 provides the address pulse with the address voltage to the address electrodes D₁ to D₆, the scan driver 42 drives the link scan electrodes Z₁ to Z₃ sequentially, and the sustaining driver 41 drives the sustaining electrodes X₂, X₄, and X₆ simultaneously. Referring to FIG. 7, discharge occurs between the scan electrode Y₁ and the sustaining electrode X₂, between the scan electrode Y₂ and the sustaining electrode X₂, between the scan electrode Y₃ and the sustaining electrode X₄, between the scan electrode Y₄ and the sustaining electrode X₄, between the scan electrode Y₅ and the sustaining electrode X₆, and between the scan electrode Y₆ and the sustaining electrode X₆. The discharged display units of the display array 40 irradiate to form the second field, that is, the PDP 4 displays a second image. One frame with a single gray-level is composed of the first and second images.

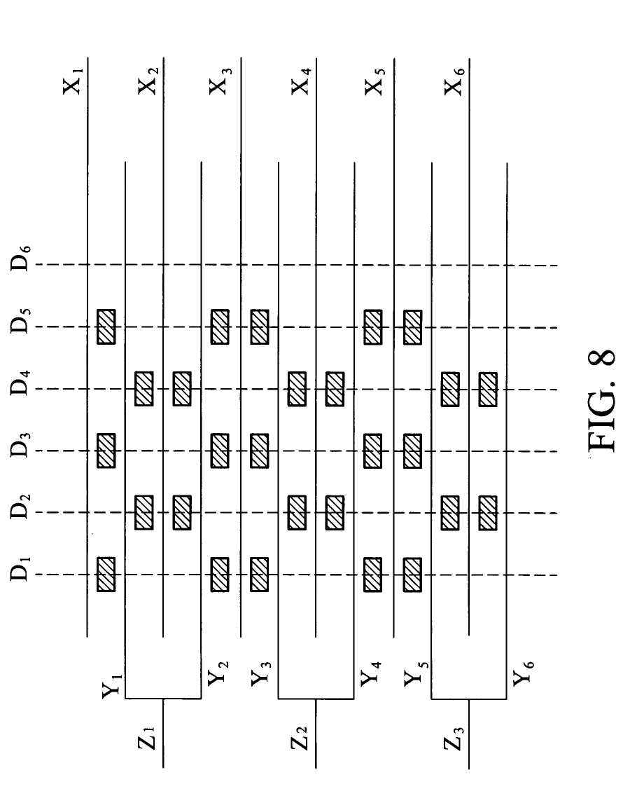

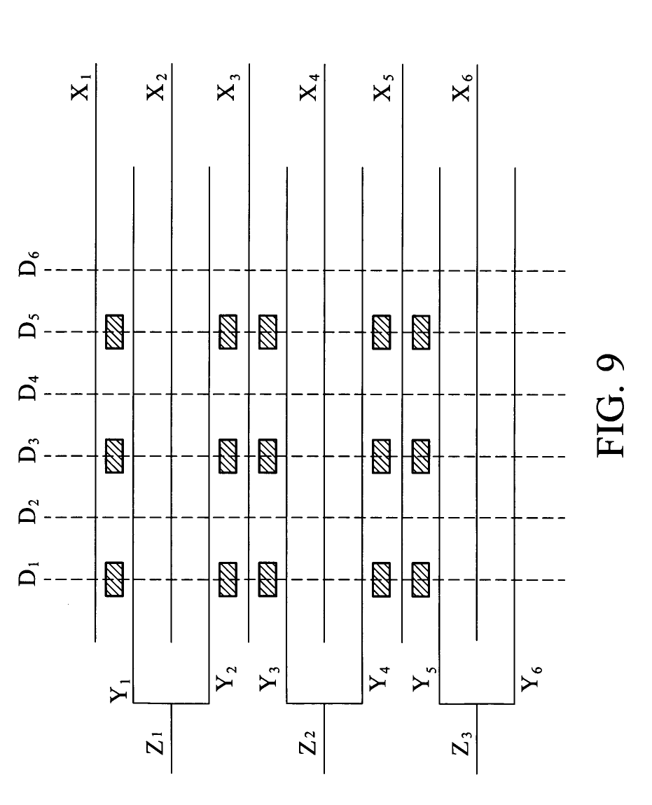

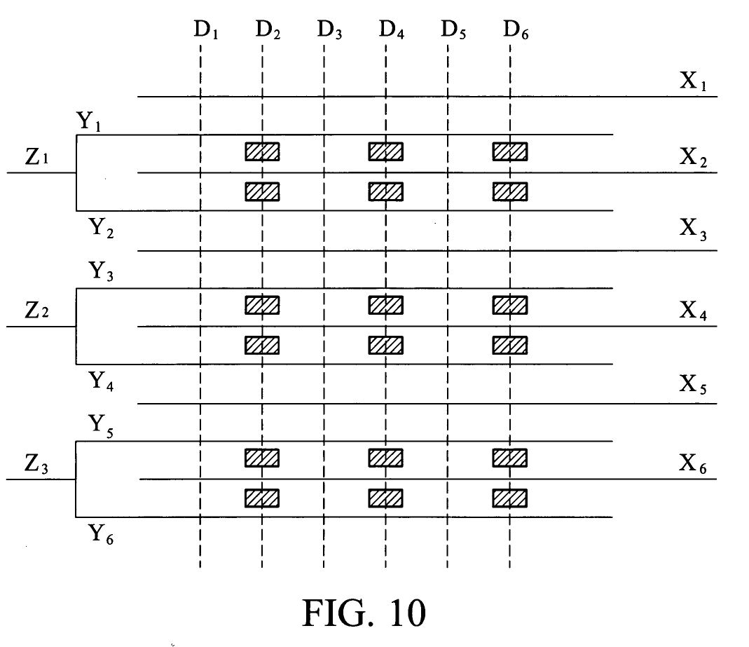

In some embodiments, except for the arrangement of the display array, the structure and control timing of the PDP are the same as those of the PDP 4 in FIG. 4. As shown in FIG. 8, the arrangement of the display array is different from that of the display array 40 in FIG. 4. Referring to FIGS. 9 and 10, the discharged display units of each field are in pairs. In the first field as shown in FIG. 9, for example, the discharge occurs between the scan electrodes Y₂ and Y₃ and the sustaining electrode X₃ to form a plurality of pairs of discharged display units. In the second field as shown in FIG. 10, for example, the discharge occurs between the scan electrodes Y₁ and Y₂ and the sustaining electrode X₃ to form a plurality of pairs of discharged display units.

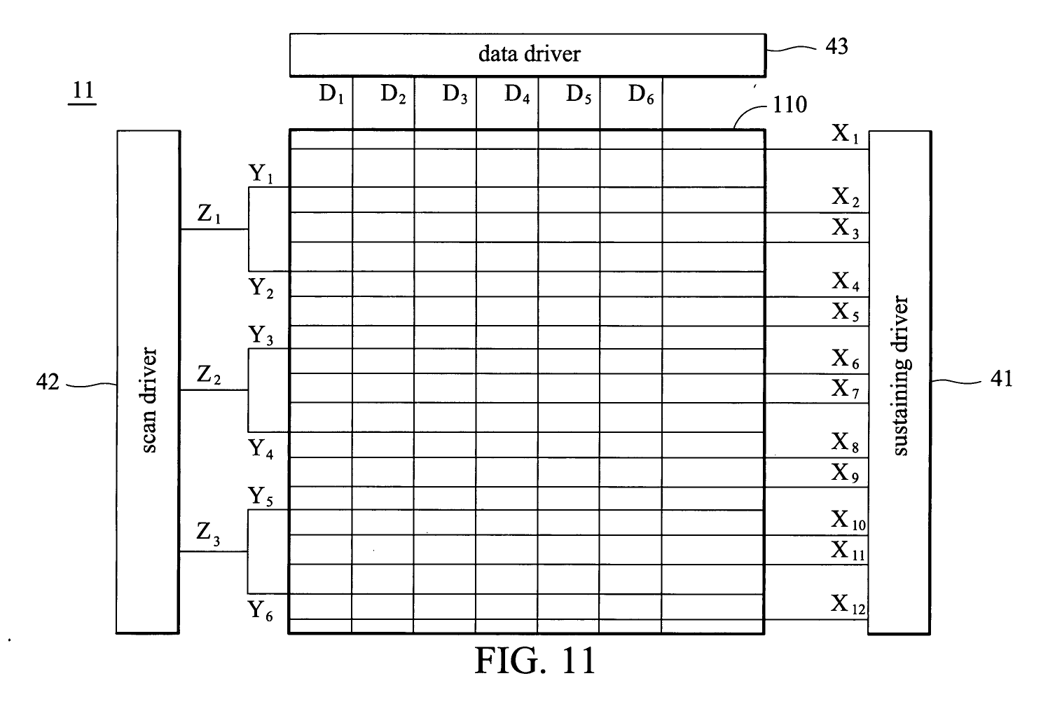

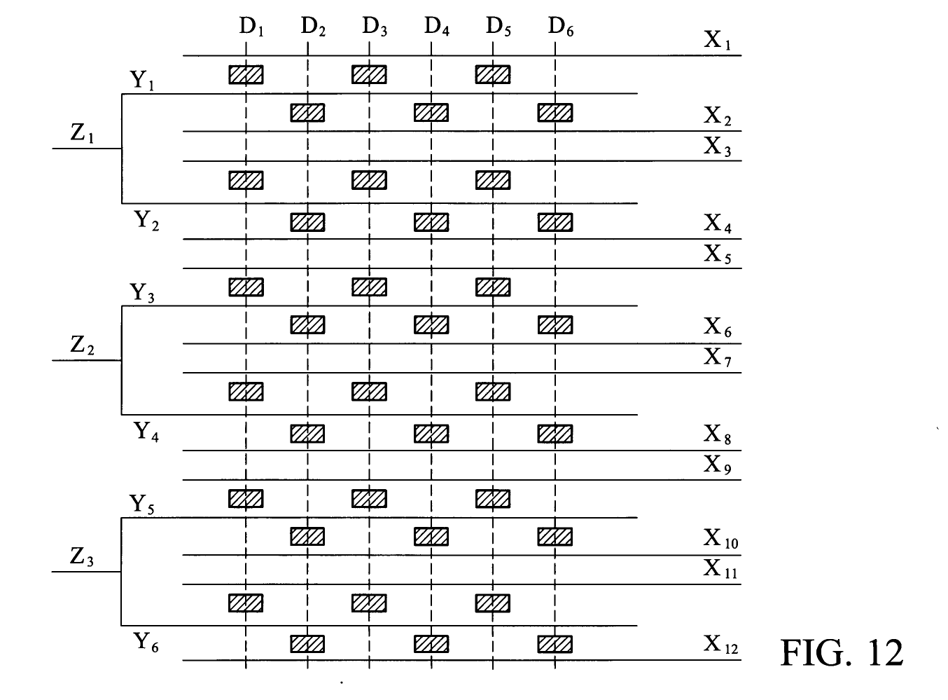

In some embodiments, as shown in FIG. 11, a PDP 11 is provided. To describe the embodiment clearly, the elements of the PDP 11 same as those of the PDP 4 are identified with the same reference numerals. Twelve sustaining electrodes X₁ to X₁₂, six scan electrodes Y₁ to Y₆, and six address electrodes D_{1 to D}₆ are provided as an example. The difference between the PDP 11 and the PDP 4 is the structure of the display array. In the display array 40 of FIG. 4, the scan electrodes Y₁ to Y₆ and the sustaining electrodes X₁ to X₆ are disposed alternately. In a display array 110 of FIG. 110, two sustaining electrodes are disposed between two scan electrodes. As shown in FIG. 12, the display units of the display array 110 are arranged in delta structure. In the embodiment of FIG. 12, twelve sustaining electrodes X₁ to X₁₂, six scan electrodes Y₁ to Y₆, and six address electrodes D₁ to D₆ are provided as an example.

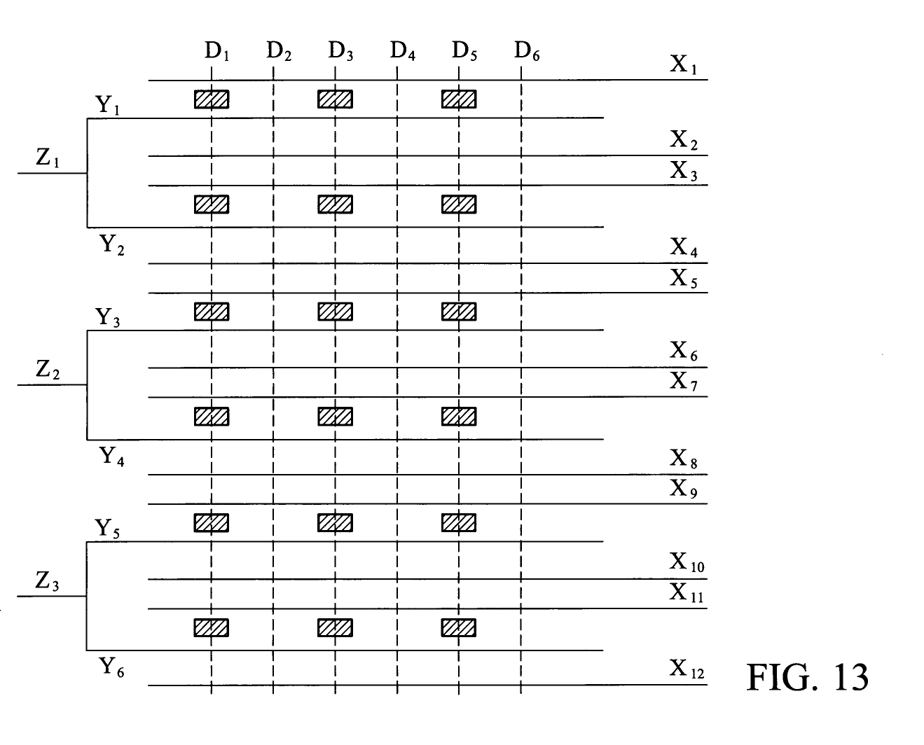

According to the embodiment, one frame is divided into a first field and second field, each having a plurality of sub-fields. Each sub-field includes three operating periods, that is, the erase period, the address period, and the sustain period. It is assumed that the PDP 11 displays an image with a single gray-level. In each sub-field of the first field, the data driver 43 provides an address pulse with address voltage to the address electrodes D₁ to D₆, the scan driver 42 drives the link scan electrodes Z₁ to Z₃ sequentially, and the sustaining driver 41 drives the sustaining electrodes X₁, X₃, X₅, X₇, X₉, and X₁₁ simultaneously. Referring to FIG. 13, the discharged display units of the display array 110 irradiate to form the first field, that is, the PDP 11 displays a first image.

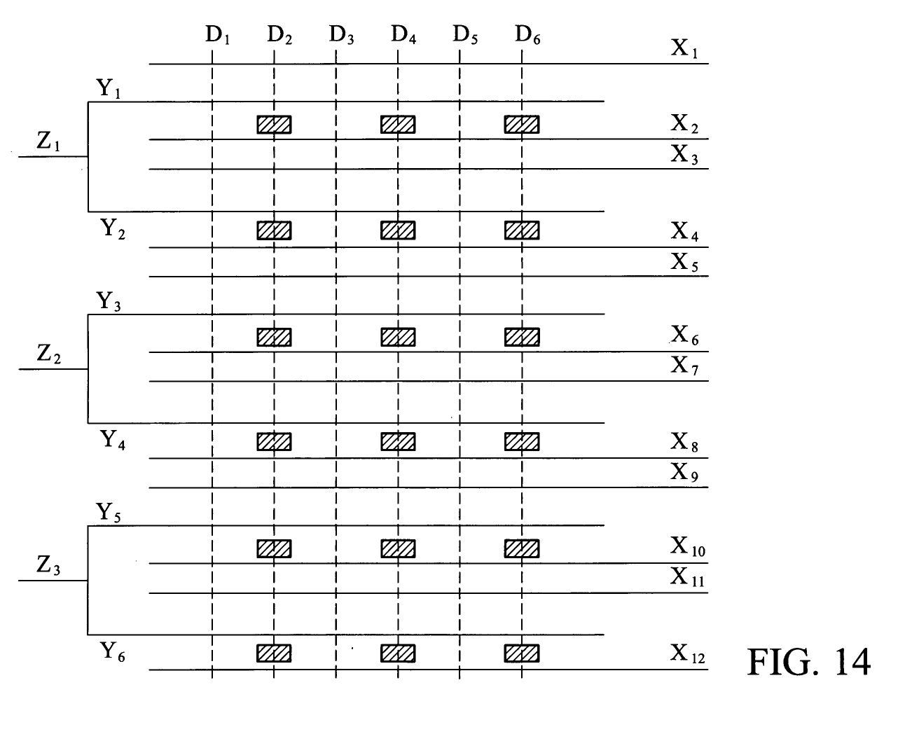

In each sub-field of the second field, the data driver 43 provides the address pulse with the address voltage to the address electrodes D₁ to D₆, the scan driver 42 drives the link scan electrodes Z₁ to Z₃ sequentially, and the sustaining driver 41 drives the sustaining electrodes X₂, X₄, X₆, X₈, X₁₀, and X₁₂ simultaneously. Referring to FIG. 14, the discharged display units of the display array 110 irradiate to form the second field, that is, the PDP 11 displays a second image. One frame with a single gray-level is composed of the first and second images.

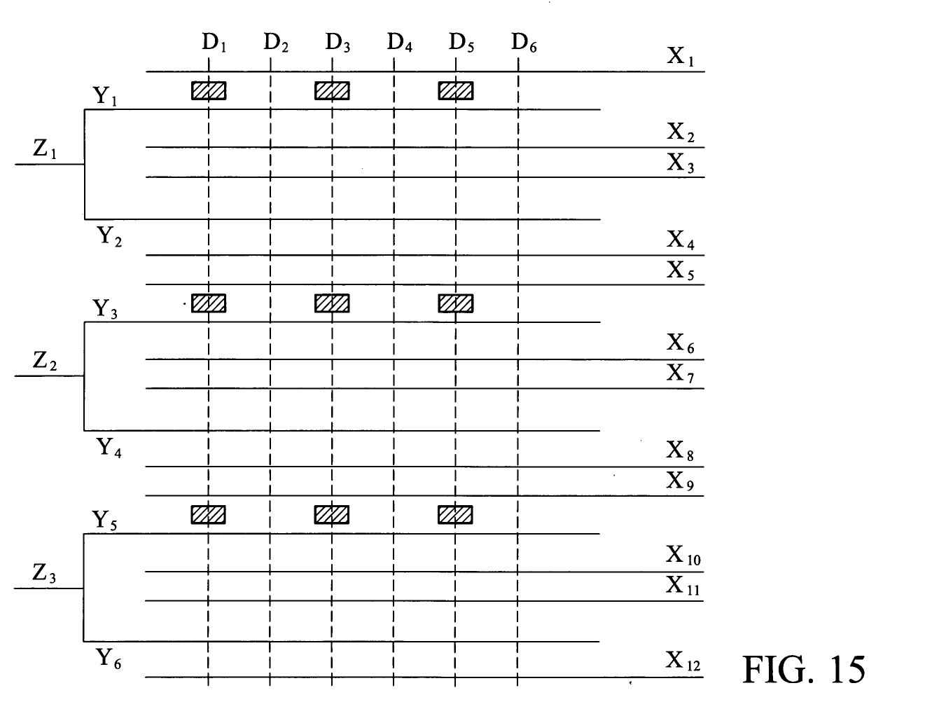

In the structure of the PDP 11, one frame can be divided to first, second, third, and fourth fields, each having a plurality of sub-fields. Each sub-field includes three operating periods, that is, the erase period, the address period, and the sustain period. It is assumed that the PDP 11 displays an image with a single gray-level. In each sub-field of the first field, the data driver 43 provides an address pulse with address voltage to the address electrodes D_{1 to D}₆, the scan driver 42 drives the link scan electrodes Z₁ to Z₃ sequentially, and the sustaining driver 41 drives the sustaining electrodes X₁, X₅, and X₉ simultaneously. Referring to FIG. 15, the discharged display units of the display array 110 irradiate to form the first field, that is, the PDP 11 displays a first image.

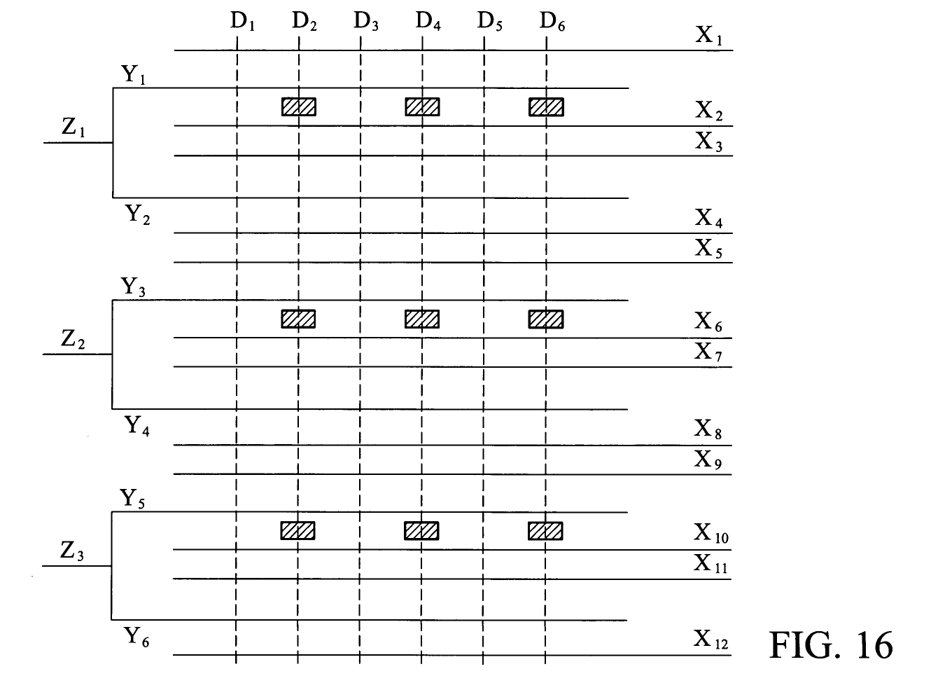

In each sub-field of the second field, the data driver 43 provides the address pulse with the address voltage to the address electrodes D₁ to D₆, the scan driver 42 drives the link scan electrodes Z₁ to Z₃ sequentially, and the sustaining driver 41 drives the sustaining electrodes X₂, X₆, and X₁₀ simultaneously. Referring to FIG. 16, the discharged display units of the display array 110 irradiate to form the second field, that is, the PDP 11 displays a second image.

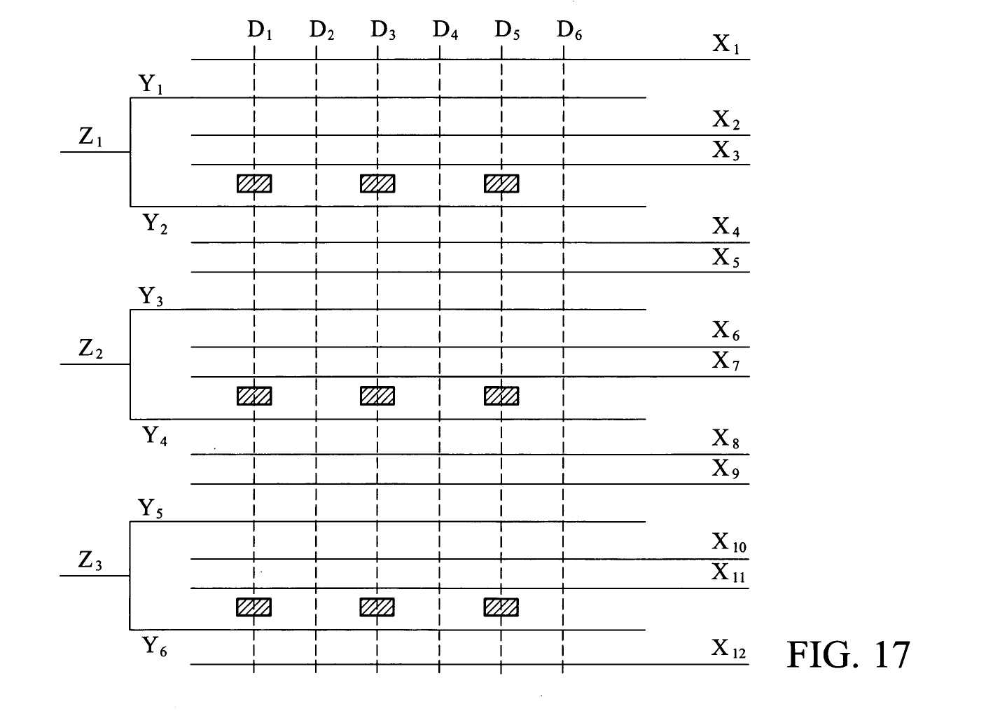

In each sub-field of the third field, the data driver 43 provides the address pulse with the address voltage to the address electrodes D₁ to D₆, the scan driver 42 drives the link scan electrodes Z₁ to Z₃ sequentially, and the sustaining driver 41 drives the sustaining electrodes X₃, X₇, and X₁₁ simultaneously. Referring to FIG. 17, the discharged display units of the display array 110 irradiate to form the third field, that is, the PDP 11 displays a third image.

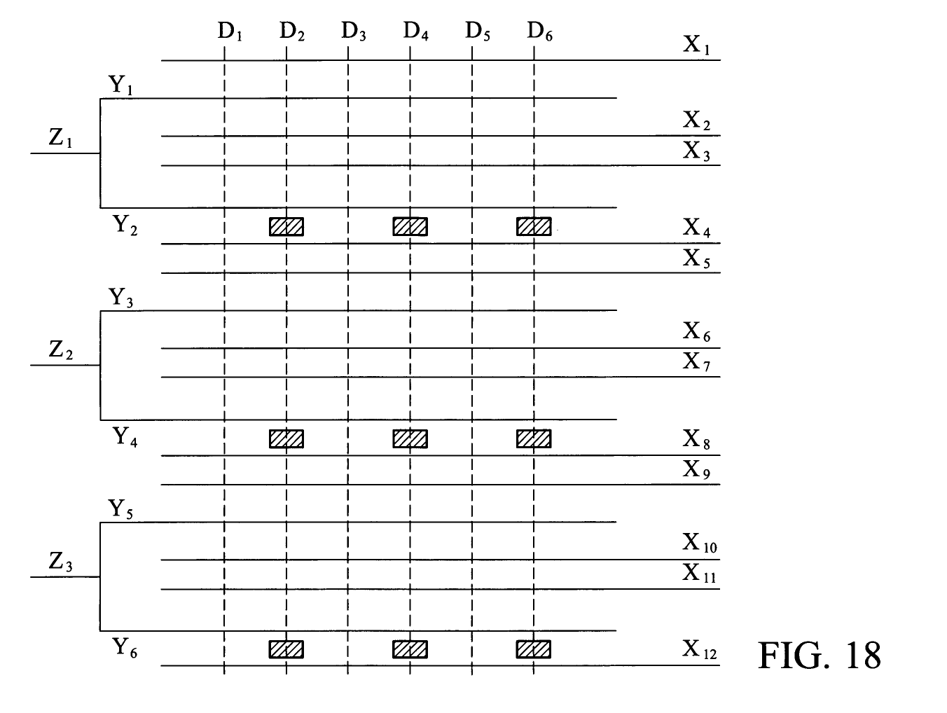

In each sub-field of the fourth field, the data driver 43 provides the address pulse with the address voltage to the address electrodes D₁ to D₆, the scan driver 42 drives the link scan electrodes Z₁ to Z₃ sequentially, and the sustaining driver 41 drives the sustaining electrodes X₄, X₈, and X₁₂ simultaneously. Referring to FIG. 18, the discharged display units of the display array 110 irradiate to form the fourth field, that is, the PDP 11 displays a fourth image. One frame with a single gray-level is composed of the first, second, third, and fourth images.

According to the above embodiments, since each link scan electrode is coupled to two scan electrodes, the number of electrodes coupled to the scan driver can be decreased by half, thereby decreasing the number of scan drivers in large size PDPs.

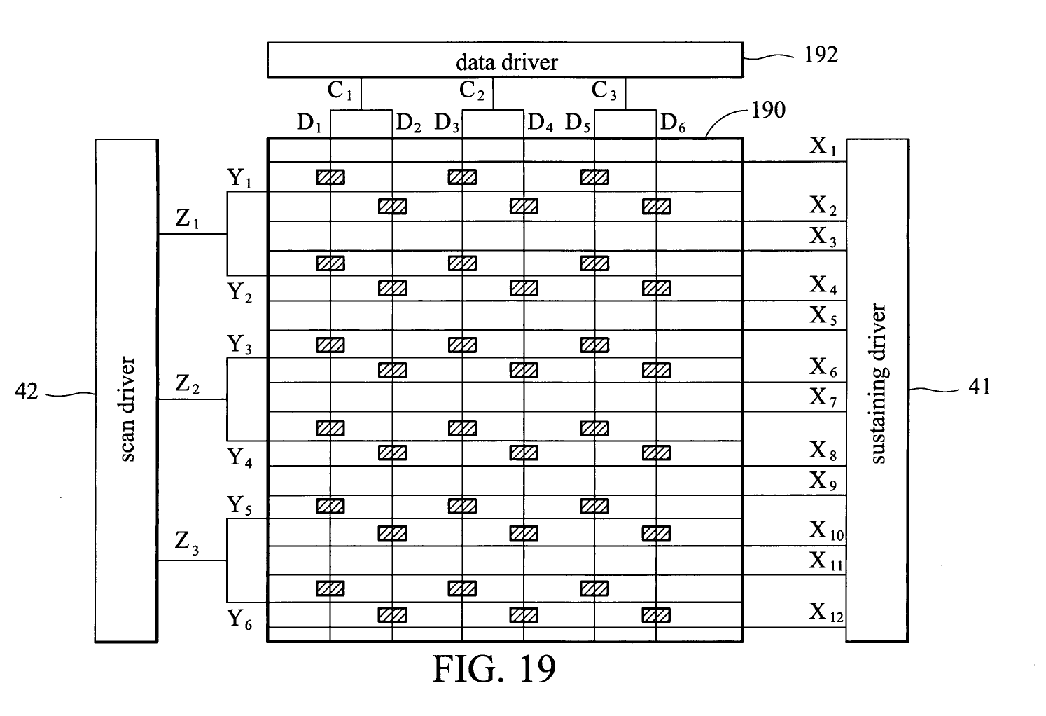

In some embodiments according to the PDP 11 in FIG. 11, since the discharging display units are disposed in the same column in each field, as shown FIGS. 12 to 17, two adjacent address electrodes can be coupled to each other. Referring to FIG. 19, a PDP 19 is provided. In FIG. 9, the electrodes D₁ and D₂ are coupled to a link address electrode C₁, the electrodes D₃ and D₄ are coupled to a link address electrode C₂, and the electrodes D₅ and D₆ are coupled to a link address electrode C₃. Thus, a data driver 192 is coupled to only three link address electrodes C₁ to C₃. The number of link address electrodes is half of that address electrodes. Compared with the conventional PDP, the number of data drivers is decreased.

According to some embodiments, when the PDPs of the embodiments are applied in large plasma display devices, the number of scan drivers and that of data electrodes are decreased, resulting in decreased size and cost.

While the invention has been described in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A plasma display panel comprising:
a display array constructed by a plurality of sustaining electrodes, a plurality of scan electrodes, and a plurality of address electrodes, wherein the scan electrodes are parallel to the sustaining electrodes, each scan electrode is disposed between two sustaining electrodes, and each address electrode intersects the sustaining electrodes and the scan electrodes at a distance; and
an electrode driver driving a first scan electrode and a second scan electrode adjacent to the first scan electrode;
wherein, in a first period, discharge occurs between the first scan electrode and a first sustaining electrode on one side of the first scan electrode to display a first image; and
wherein, in a second period different from the first period, discharge occurs between the first scan electrode and a second sustaining electrode on the other side of the first scan electrode to display a second image.

2. The plasma display panel as claimed in claim 1, wherein the second sustaining electrode is disposed between the first and second scan electrodes.

3. The plasma display panel as claimed in claim 1, wherein the sustaining electrodes comprise third and fourth sustaining electrodes respectively disposed on two sides of the second scan electrode.

4. The plasma display panel as claimed in claim 1, wherein each scan electrode controls a plurality of display units arranged in delta structure on two sides of the corresponding scan electrode.

5. The plasma display panel as claimed in claim 1, wherein each scan electrode controls a plurality of display units arranged in pairs on two sides of the corresponding scan electrode.

6. A driving method of a plasma display panel comprising a plurality of sustaining electrodes, a plurality of scan electrodes, and a plurality of address electrodes, the scan electrodes parallel to the sustaining electrodes, each scan electrode disposed between two sustaining electrodes, each address electrode intersecting the sustaining electrodes and the scan electrodes at a distance, wherein the driving method comprises:
(1) driving a first scan electrode and a second scan electrode adjacent to the first scan electrode simultaneously to discharge between the first scan electrode and a first sustaining electrode on one side of the first scan electrode to display a first image; and
(2) driving the first and second scan electrodes simultaneously to discharge between the first scan electrode and a second sustaining electrode on the other side of the first scan electrode to display a second image.

7. The driving method as claimed in claim 6 further comprising:
(3) driving the first and second scan electrodes simultaneously to discharge between the second scan electrode and a third sustaining electrode on one side of the second scan electrode to display the first image; and
(4) driving the first and second scan electrodes simultaneously to discharge between the second scan electrode and the second sustaining electrode disposed between the first and second scan electrodes to display the second image;
wherein steps (1) and (3) are executed simultaneously, and steps (2) and (4) are executed simultaneously.

8. The driving method as claimed in claim 6 further comprising:
(5) discharging between the second scan electrode and a third sustaining electrode on one side of the second scan electrode to display the first image; and
(6) discharging between the second scan electrode and a fourth sustaining electrode on the other side of the second scan electrode to display the second image;
wherein steps (1) and (5) are executed simultaneously, and steps (2) and (6) are executed simultaneously.

9. The driving method as claimed in claim 6 further comprising:
(7) discharging between the second scan electrode and a third sustaining electrode on one side of the second scan electrode to display a third image; and
(8) discharging between the second scan electrode and a fourth sustaining electrode on the other side of the second scan electrode to display a fourth image.

10. The driving method as claimed in claim 6, wherein each scan electrode controls a plurality of display units arranged in delta structure on two sides of the corresponding scan electrode.

11. The driving method as claimed in claim 6, wherein each scan electrode controls a plurality of display units arranged in pairs on two sides of the corresponding scan electrode.
